(19) United States
(12) Patent Application Publication
(10) Pub. No.: US 2002/0178054 A1
(43) Pub. Date: Nov. 28, 2002

(54) Permission-based marketing and delivery system and method

(76) Inventor: Jamie Ader, Santa Monica, CA (US)

Correspondence Address: OPPENHEIMER WOLFF & DONNELLY LLP, Attn: Spyros J. Lazaris, Esq., 2029 Century Park East, Suite 3800, Los Angeles, CA, 90067, US

(21) Appl. No.: 09/863,500

(22) Filed: May 23, 2001

(51) Int. Cl. G06F 17/60; G06F 7/00; G06F 17/00

(52) U.S. Cl. 705/14; 707/104.1

(57) ABSTRACT

A customizable content delivery system includes a computer network and user interface applications to help end users find, select and receive content. These end users have the additional ability to select promotional materials to be included with ordered content, which may have the effect of reducing the price to paid for the content. Content and promotional materials are registered and ordered electronically by end users. The system therefore provides an electronic clearinghouse for content owners and providers of promotional material to coordinate their activities with end users and provide specific media and services to targeted audiences.

### BACKGROUND OF THE INVENTION

1. Field of the Invention

The present invention relates to the marketing organization and delivery of various types of digital media content to end users. Specifically, the invention provides a system of layered categories for organizing digital media into thematic special interest categories, allowing end users to access their special interests and create custom compilations of media and advertising.

2. General Background and State of the Art

In the prior art, content with mainstream appeal, and usually stars, is distributed to reach mainstream markets with blanket advertising and huge budgets. Advertisers also try to take a blanket approach to reaching their markets but find it expensive and inefficient. Disinterested customers tune out advertising that they feel is not related to their interests. Content owners and advertisers therefore have difficulty delivering promotional materials to acquire customers cost-efficiently, because with mass advertising and mass media they cannot specifically target their media to the customers most willing to respond to the content and/or advertising. Further, only a small portion of the media titles created ever receive distribution. It takes large volume unit sales forecasts to offset the upfront investment traditionally involved with distributing a media title. Therefore only a small percentage of the media produced is ever delivered to end users.

The prior art has not applied the methods of ordering customized content and customized advertising to provide individual selection of media and advertising based on the special interests of end users. Online and offline vendors, television channels, wireless telephone providers, and all other possible providers of content have a need to sell media and promote products. Similarly, customers have a need to spend their time and money most efficiently by selecting, purchasing and viewing only the digital media and advertising most likely to appeal to them.

### INVENTION SUMMARY

The present invention provides a system and method of integrating all parties that have a stake in content sales: content owners, e-tailers, retailers, advertisers, broadcasters, etc. to work together to sell digital media to finely targeted audiences. The present invention provides a clearinghouse for these parties to accomplish these objectives. The present invention allows any qualified owner or distributor to register content into a database. This is performed by executing a template defining items such as market, audience and other properties that will help identify the special interest appeal of the content. The present invention also allows advertisers to register advertising and promotional materials by filling out a template defining advertising special interest properties and the targeted special interest properties of their campaigns. Additionally, the present invention allows both content owners and advertisers to upload text and graphic data and materials to servers accessed via the Internet. Such graphic materials may include but are not limited to trailers, clips, logos, and advertisements. The present invention also supports a database that holds a directory of content, editorial comments related to the content, all of the marketing informational materials related to the content, and in some cases the digitized content itself. Additionally, the present invention includes automatic tracking data showing audience rating or ranking of particular content within special interest categories.

The invention therefore provides a system of layered categories for organizing digital media into thematic special interest categories, allowing end users to access their special interests and create custom compilations of media and advertising. If the end user does not know the special interest they wish to explore, the system guides them to create their own special interest profiles (themes, moods, personality, situations, experiences) that lead them to discover relevant special interest categories for media. This system provides media owners and advertisers with the ability to target special interest groups and provide end users with the ability to select the specific media that is most likely to appeal, in the order of its ranking if chosen, and commercial messages, in the order of ranking if chosen, to be inserted in the media in return for a discount on the media.

Once the desired material is in the database, the present invention matches advertisers with digital media content that meets their campaign targets and provides a selection of that content along with the advertising and marketing campaigns to the targeted special interest end users. The present invention employs a delivery mechanisms to allow content owners, and advertisers to market and distribute their content through these distribution channels targeting specific end users via their special interests. The offer for advertisers is a highly targeted distribution medium. The media selection is provided with a value proposition that when advertising and/or marketing materials are viewed, discount subsidies are applied to the purchase of the media. Additional subsidies can be earned when the end user provides a ranking/rating of the media.

The present invention is therefore designed to facilitate inventory selection for end users. The present invention assists these end users by matching their special interests with a selection of content organized in rankings/ratings of most popular to least popular. The system does this by having the end users register their special interests into the data base. It then matches their special interest properties with media and advertising properties. When end users want guidance to discover their special interest categories and media that meets their needs, the system helps them identify the categories best suited to them and their situations by responding to a series of questions. The present invention makes the selection process of media fast, easy, cost-effective and satisfying. The present invention offers content owners and distributors a consistent methodology of reaching end users cost-effectively with the content most likely to have specific appeal to them. The system directs end users to where the media can be acquired and facilitiates their ability to purchase it there.

The present invention also provides end users with an incentive for viewing digital media content and advertising and choosing to pass it along to another end user on a referral basis. End users may earn subsidies to apply to future purchases.

The present invention also provides end users with an incentive for providing feedback by ranking the digital media content and advertising. End users may earn subsidies to apply to future purchases by providing this information.

It is accordingly one object of the present invention to allow qualified content owners and advertisers to register digital media content and advertising campaigns into a database. It is another object of the invention to match advertisers with the digital media content that appeals to the same special interest groups. It is another object of the invention to execute both on and offline marketing campaigns to reach the targeted special interest end users for the digital media content and advertising. It is a further object of the invention to give an end user a discount for accepting certain advertising. It is yet another object of the invention to provide content owners and advertisers with feedback from end users about the performance of the content.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is an overall block diagram representation of the permission-based marketing and delivery system of the present invention;

FIG. 2 is an additional block diagram representation of front-end applications and database functions of the permission-based marketing and delivery system of the present invention;

FIG. 3 is a flowchart representation of system architecture involved in the present invention; and

FIG. 4 is a flowchart representation of the process of selecting from special interest categories.

### DETAILED DESCRIPTION OF THE EMBODIMENTS

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

The present invention enables remote users to access and provides intelligent data mining that searches a database of digital media content information, and select the content they wish to review and/or purchase in a specific special interest category. After the selection of content, the user is given the option of determining whether advertising is to be included in the finished product in exchange for a reduction in the cost of the product. If advertising is selected, the user is then given the opportunity to choose the advertisement to be included from advertisers available in the special interest category. The content is then assembled including the advertising, if any, and the assembled content is passed to a delivery system which either creates the physical product to be shipped to the customer or electronically transmits the content and advertising directly to the customer. Content includes, but is not limited to, advertising, movies, books, magazines, and any other type of media, digital or otherwise.

The infrastructure for this system is a computer network which enables each component of the system to communicate to find, define, customize, purchase, manufacture, and deliver content for the consumer. In one embodiment, the computer network is the global Internet computer network, which uses Transmission Control Protocol/Internet Protocol (TCP/IP) to exchange data between machines. Management and delivery of data necessitates a high bandwidth intra-network infrastructure (LAN).

Together the integrated components of this system enable web browsers to view the system's user interface applications remotely, from anywhere on the computer network, using TCP/IP to exchange data. The user interface applications employ the widely-used “shopping cart” metaphor for storing and managing all of the content a user is interested in purchasing. When a user wishes to purchase content, the system then suggests advertisers to the user for content based on demographic information collected about that specific user, and the user interface will collect payment information, such as credit card details, and begin the process of assembly, manufacture and delivery of the content.

The user's order then proceeds into a queue to await manufacture. When the manufacturing component is free, the order is removed from the queue, the content is then assembled, and passed to the manufacturing component, where physical product including the content is manufactured. After manufacture, the product is packaged and shipped to the user. An important note is that a manufacturing facility does not need to be physically located near the central database or user interface applications. By duplicating the content database, order queue, or the server, and reproduction hardware in various geographical locations, fulfillment centers shall be theoretically dispersed around the globe. This enables orders to be fulfilled from multiple locations, which results in greater overall scalability.

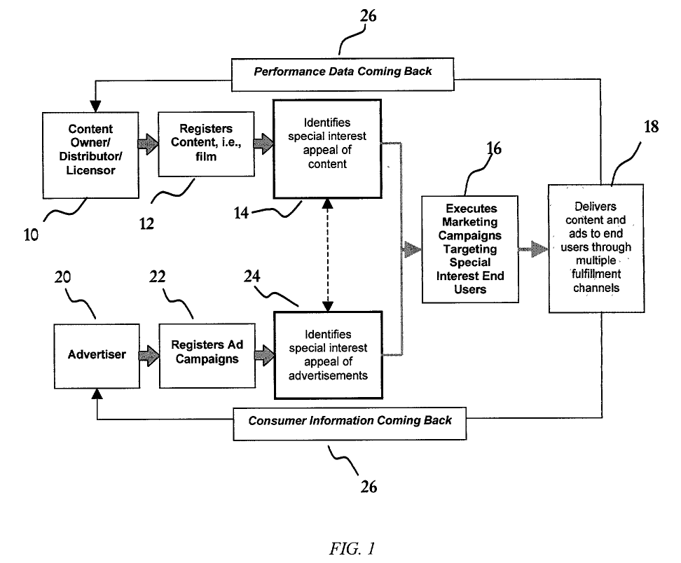

FIG. 1 is an overall block diagram representation of the permission-based marketing and delivery system of the present invention. Blocks 10 and 12 of FIG. 1 show a content owner and/or distributor registering content with the system. In one embodiment, this is performed by completing a marketing template and uploading contents material to the central database. Once the content owner and/or distributor has registered content with the central database, the system identifies demographic appeal of the content, as shown in block 14. This step is performed using the information contained in the template completed by the content owner/distributor. Blocks 20 and 22 show the steps of advertisers registering and uploading advertising and promotional campaigns with the system. This is also accomplished by filling out a template and uploading advertising and promotional materials to the central database. Once the content and advertising have been registered and uploaded, block 24 shows the step of matching advertising campaigns to content in the central database. In this respect, blocks 14 and 24 are performed internally by the system as a way of matching advertising materials and content, based upon targeted demographic audiences. Block 16 shows the next step of executing niche marketing campaigns. The next block, block 18, shows the step of delivering content and promotional material through various channels. Such channels may be over an additional communications network directly to a remote computer, or any other way of delivering product containing content either electronically or otherwise. Blocks 26 show an additional step of providing feedback data to the content owner/distributor and/or advertiser. With respect to content owners and distributors, performance data related to sales of the content is provided by the system to the content owner. Similarly, the system provides advertisers with information on the type of consumer purchasing promotional materials of the advertisers.

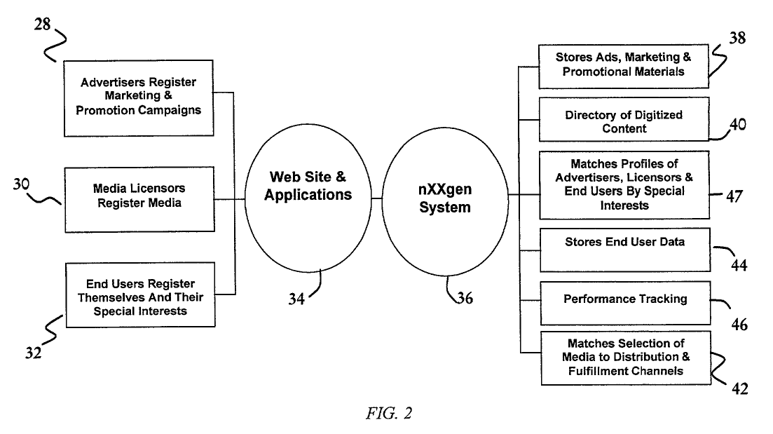

FIG. 2 is an additional block diagram representation of front-end applications and database functions of the permission-based marketing and delivery system of the present invention. Blocks 28, 30 and 32 show remote clients that utilize the user interface applications in block 34 of the present invention. The end user application shown in block 34 allows advertising and promotion, distribution, signup and placement, and niche marketing and promotion campaign applications all to be uploaded to the central database in block 36. The present invention uses the information stored in block 36 to perform several functions, which are shown in blocks 38 through 47. The functions performed by the present invention include storing of marketing and promotional materials, maintaining a directory of digitized content, matching selection of media to distribution and fulfillment channels, matching profiles of advertisers, licensors and end users by special interests, and providing an audience tracking function to further provide the ability to fine-tune their target audiences in the future.

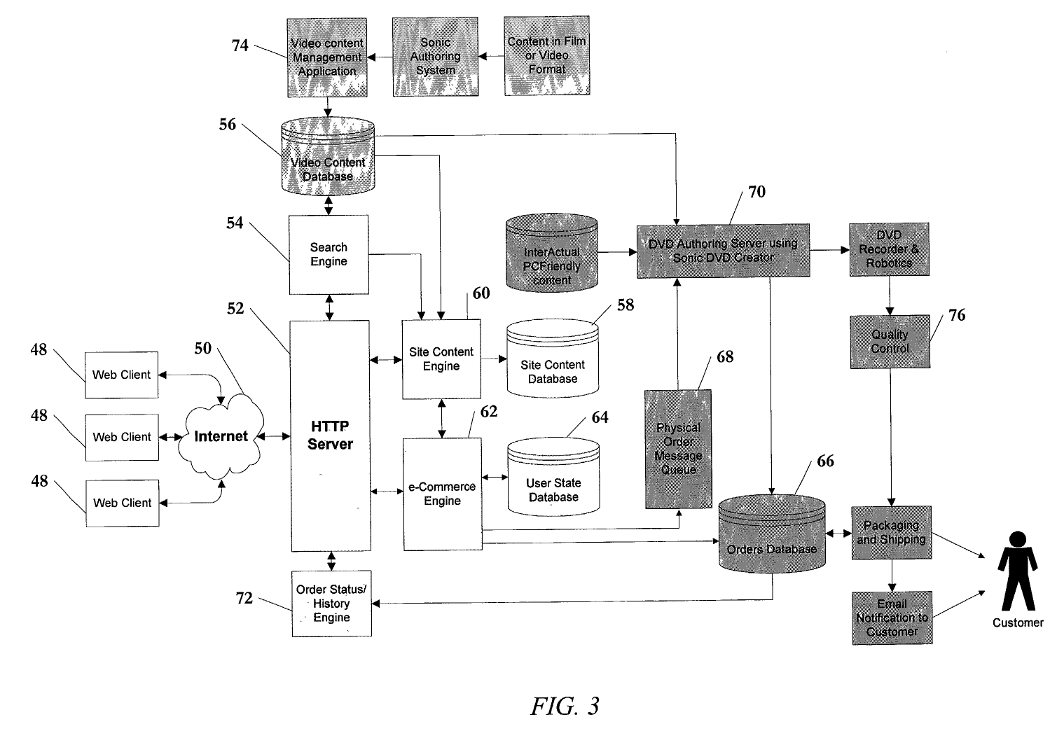

FIG. 3 is a flowchart representation of system architecture included in the present invention. FIG. 3 displays a particular embodiment of the present invention in which the content is delivered to the end user in DVD format. However, it is to be understood that any type of device may be used as a carrier to deliver content ordered by an end user, including but not limited to devices such as CD-ROM and video cassette tape. FIG. 3 shows web clients of blocks 48 connected to an Internet 50. Web clients 48 may include any number of remote locations through which users, owners and distributors, and advertisers may connect to the computer network 50 of the present invention. Web clients 48 interact with the computer network 50 through a series of user interface applications. Web clients 48 may include computer terminals at a variety of locations which are capable of accessing the user interface applications. In this embodiment, the computer network 50 of the present invention is the Internet 50. The computer network 50 also includes a server 52, a search engine 54, and a content database 56, shown in the embodiment shown in FIG. 3 as a video content database to be used in authoring DVDs. The content database 56 may include a plurality of databases at different geographic locations, each containing content uploaded by content owner and/or distributor. The system also includes a site content database 56 coupled to a site content engine 60. The site content database 58 includes the template information submitted by content owners and distributors as well as advertisers, and the actual promotional material uploaded by those advertisers. The system also includes an e-commerce engine 62 coupled to a user-state database 64, an orders database 66 and a physical order message queue 68. These devices assist the computer network in processing and executing orders by end users. The physical order message queue 68 and the orders database 66 couple with the DVD authoring server 70 to initiate the process of transferring content to the DVD embodiment. From there, DVD products are processed and shipped to the consumer.

The components of the system can be divided into three distinct categories: Client control, content management, and fulfillment center. The Client control process enables remote clients to view and manipulate the user interface for the system in order to control the ordering and manufacturing process. The Client (such as web client 48) is a machine on the computer network 50 running web browser software such as for example Netscape Navigator or Microsoft Internet Explorer. This web browser can be running on any hardware/operating system platform capable of communicating using the Hypertext Transport Protocol (HTTP) over TCP/IP, rendering information sent by the system in Hypertext Markup Language (HTML) and capable of running script written in the JavaScript language and applications or applets written in the Java programming language.

The Clients will communicate over the computer network 50 such as the Internet with the HTTP Server 52. The server 52 is responsible for serving the above-mentioned text, script, and programs to many Clients that are simultaneously connected to the system. The server 52 functionality can be achieved using an existing HTTP server product, such as Microsoft Internet Information Server, Netscape Server, or Apache. Several “engines” manage the integration between the server 52 and the rest of the system. These engines can be implemented using one or more commonly accepted HTTP server integration technologies, such as Common Gateway Interface (CGI), Java servlets, Active Server Pages (ASPs), Internet Server Application Programmer Interface (ISAPI) and Netscape Server Application Programmer Interface (NSAPI).

The search engine 54 provides the means by which a client can search for preferred video content. The search engine 54 identifies and retrieves video content from the online content database 56. The text content included within the system is obtained via the site content engine 60 and the site content database 58. The content database 56, a database stored and managed using the Oracle 8i Database Management System with Oracle interMedia, holds all of the system's video content and attributes of the content, and it is populated and maintained by the content management system described herein. Effectively, the content database 56 is the product inventory for this system, maintaining potentially terabytes or petabytes of video assets. Using the search engine 54, clients are able to enter statements and specify search criteria in order to find specific video content elements in the inventory or find further information on said content.

The site content engine 60 works with the site content database 58, the content database 56, and HTML documents located on the server 52 in order to provide the user interface applications to the Clients. The site content database 58 can be maintained on a separate Oracle database or a database more conducive to interaction with a particular HTTP server. The site content engine 60 gathers information from all of these sources, formats it into HTML and script templates, and passes that information back to the browser via the server 52. A shopping cart engine enables clients to “shop” for video content by selecting the various pieces of video content they wish to purchase and storing references to the video content in the site content database 58. An HTTP “cookie” or similar method of state management will be used to maintain the correlation with specific Client sessions and shopping cart data.

The e-commerce engine 62 is responsible for accepting customer payments information, verifying payments details with a financial clearing house component, and starting the order fulfillment process. Prior to fulfilling the orders, the e-commerce engine 62 selects the appropriate advertising content for the given order based on the contents of the order and/or the profile or demographic data of the purchaser and provides the purchaser with the opportunity to include this advertising in exchange for some amount of discount on the cost of the products ordered. Order fulfillment begins by posting a message to the physical order message queue 68 to begin the physical media fulfillment process, which is described in detail below.

The order status/history engine 72 communicates with the orders database 66 in order to provide clients with the status of past orders. Examples of status information include whether an order had been manufactured, whether it has been shipped, and package tracking information. This status information is assembled in HTML format and sent back to the Client.

The content management portion of the system deals with the acquisition, addition, and maintenance of video content. The process begins with content in its original format, which is converted to the proper format for digital storage using DVD Creator from Sonic Solutions. The appropriate format for video data is the MPEG-2 format, which is the native storage format for DVD-Video. After conversion, a human operator will employ the video content management application 74, which communicates directly with the content database 56 to add, modify, delete, and otherwise maintain the video content assets.

The fulfillment center is the portion of the system that transfers the purchased video content from the content database 56, assembles the content in the correct order and format, and transfers the content to physical DVD media. This process begins when the order fulfillment engine pulls a manufacture request from the physical order message queue 68. Ideally, the physical order message queue 68 will be implemented using existing technology, such as Microsoft Message Queue (MSMQ), Microsoft COM+, or IBM MQ Series. The format of the messages placed in the queue contains references to the video content (from the content database 56) that needs to be manufactured and references to the customer and order information (contained in the orders database 66). The order fulfillment engine also makes an entry into the orders database 66 to indicate the order is now in the manufacturing phase.

After gathering content and advertising from the content database 56, a menu system will be dynamically developed from a template, which will provide a main menu for the media, as is customary for this type of DVD media. The order also instructs the DVD Authoring systems as to which MPEG-2 encoded data to retrieve from the MPEG DVD asset storage array, and the systems create the final DVD disc utilizing those video assets. The prepared menus are also integrated into the custom DVD during these stages. The finished DVD disc data is then passed to the Rimage Producer 2000 Protégé or Rimage Producer 2000 Autostar for the final production burn onto standard DVD-R media. The Rimage DVD Producer systems control and monitor the media burner robotics to manufacture the physical media. A tracking identifier will also be printed onto the disc at this time, to “tag” it with the order identification.

After the manufacture of the DVD or other product carrier, the product undergoes a human quality control 76 phase to verify the integrity of the content. If quality control 76 is passed, the order is labeled, packaged and shipped and an entry will be made in the orders database 66 to update order status to “shipped”, and an email notification will be sent to the customer notifying them of the shipment. If quality control 76 discovers defective content, the order will be placed back in the physical order message queue 68 for remanufacture.

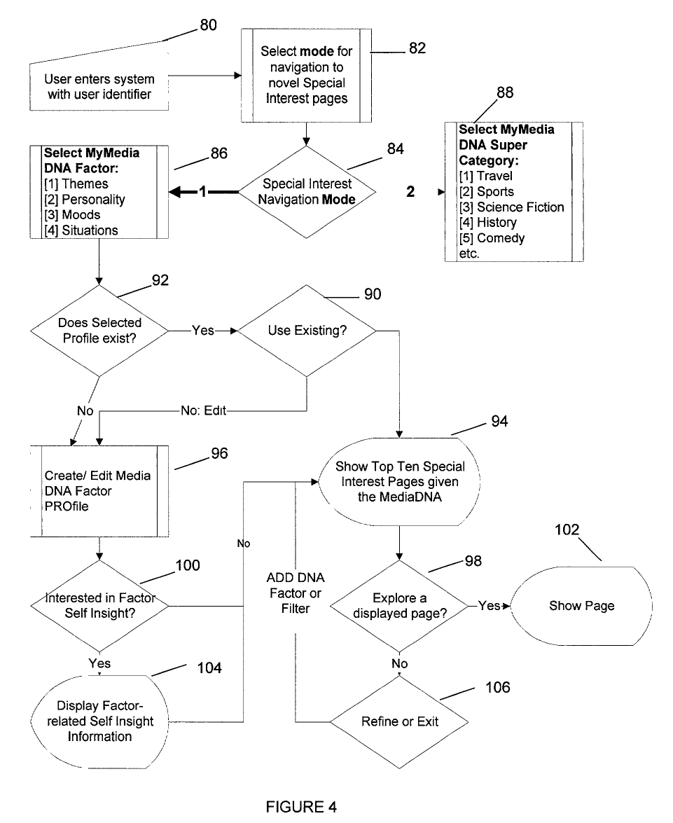

FIG. 4 is a flowchart showing the steps involved in a session process in which a user navigates the system of the present invention to discover media matching special interests in layered categories. A user enters the system in block 80 and enters a identifier to allow access to the system. The user then selects a mode for navigation to special interest pages in block 82 and then enters that navigation mode in block 84. Within the selection of mode for navigation, two mode options are presented: a mode for discovering MyMedia DNA, and a mode for layered categories. Once in the special interest navigation mode of block 84, the user may either select a MyMedia DNA factor as shown in block 86 (such as for example themes, personality, moods and situations) or select a MyMedia Super Category as shown in block 88 (such as for example travel, sports, science fiction, history, and comedy). From these blocks, the system then checks to see if a users selected profile is already existing as shown in block 92. If so, the system asks whether the user wishes to use the existing profile (as shown in block 90), and if so the user is directed to a page to view a top ranking of special interest pages given the user's DNA as shown in block 94. The user is asked whether a displayed page is to be explored (block 98), and if so the page is shown (block 102). If a displayed page is not to be explored, the system adds a DNA factor or filter and repeats the process or exits the system, as shown in block 106.

If no profile is already existing, or the user wishes to edit their existing profile, then the system proceeds to create or edit a user profile as shown in block 96. The system asks whether the user is interested in factor self-insight (block 100). If no, the system proceeds to display a ranking of special interest pages in block 94. If yes, the system displays factor-related self-insight information (block 104) and then proceeds to display the ranking of special interest pages as shown in block 94.

The present invention additionally provides services such as helping members find the specific media in categories they want and need, displaying a selection of available titles within each category, providing information on the selected titles within a category, advising members on titles to buy based on the shared experiences of others within that special interest group, lowering the price by offering advertising of choice, offering multiple fulfillment methods including custom CDs/DVDs, organizing special promotions including branded programming to highly targeted markets, and facilitating low customer acquisition cost for advertisers.

The present invention also includes a media mapping function to facilitate the selection of media based upon layered categories and special interests. Media maps are created in one of two ways. One way is an immediate drill down to special interest domains via hierarchically organized special interest categories (illustrated partially below for the SPORTS Super-Category—one of 12-20 such high level categories of Special Interest Domains). SPORTS includes Team Sports>(Major Category), Played on Ice>(Minor Category), Hockey (Special Interest Domain), Curling, Played in the Water>, Water Polo, Team Relay Swimming, Team Synchronized Swimming, Played on a marked field>, Soccer, Football, Basketball, Baseball, Tennis Doubles, Lacrosse, Individual Sports. A second way of creating a media map is through a journey of media interest Discovery (MyMediaMapper) by completing one or more optional Media Interest PROfiles {Theme PROfile, Mood PROfile, Personality PROfile, Time PROfile, Location PROfile) or Media Motivators {Situations, Goals, Experiences). Both ways of creating media maps cumulatively build the member's special interest map.

The audience for media may be directed to several types of categories, such as Primary Language (English, French, German, Italian, Spanish) and Dialect (Business Professionals, Skilled and Unskilled Laborers, Mothers with Children, College Students, Teenagers). Media may also be directed to a particular theme, such as Realistic (practical, athletic, straightforward/frank, mechanically inclined, nature oriented), Investigative (inquisitive, analytical, scientific, observant, precise scholarly, cautious, intellectually self-confident, introspective, reserved, broad-minded logical, complex, curious), Artistic (creative intuitive imaginative innovative unconventional emotional independent expressive original introspective impulsive sensitive courageous open complicated idealistic nonconforming), Social (friendly, helpful idealistic insightful outgoing understanding cooperative generous responsible forgiving patient empathic kind persuasive), Enterprising (self-confident assertive sociable persuasive enthusiastic energetic adventurous popular impulsive ambitious inquisitive agreeable talkative extroverted spontaneous optimistic initiate projects convince people to do things your way sell things or promote ideas give talks or speeches organize activities lead a group persuade others make decisions affecting others be elected to office win a leadership or sales award start your own service or business campaign politically meet important people have power or status), and Conventional (conservative, well-organized accurate numerically inclined, family oriented, methodical conscientious efficient conforming orderly practical thrifty systematic structured polite ambitious obedient persistent).

Media may also be directed according to a particular mood, such as Angry/Disgusted, Tired/Vorn Out, Anxious/Nervous, Depressed/Sad, Sexy/Romantic, Happy/Elated, Curious/Thoughtful, Calm/Serene, and Mischievous/Funny. Media may also be directed to a particular timeframe, such as time based upon period depicted, for example Geologic (more than 100,000 years ago), Tribal Age (from 100,000-5000 BC), Agricultural Age (from 5000 to 1000 BC), Age of Trade (from 1000 BC to 1800 AD), Industrial Age (19^{th} Century), Financial Age (1900-1960), Information Age (1960-Present), Near Future (21^{st} Century), Distant Future (22^{nd} Century and beyond), and multiple periods. Additionally, timeframe may be based upon when created, such as Pre-Classical, Classical, Roaring 20s, Dirty 30s, Forties, Fifties, Sixties, Seventies, Eighties, Nineties, and New Millennium. Media may be layered according to country of origin as well.

Media may also be layered according to personality, such Counselor, Visionary, Leader, Observer, Planner, Persuader, and Advisor. The personality function is a component provided to the system of the present invention by Behavior Description Systems, PO Box 5546 Station A, Calgary, Alberta, Canada, T2T 1K4.

Goals may also be a category, having possible subcategories such as Comfort/Feel Better, Become fit, Acquire/improve a knowledge or skill, and Getting a date. Situations and/or experiences may also be used to organize media, such as Getting married, Getting dumped, Getting divorced, and Starting a new job.

It is to be understood that other embodiments may be utilized and structural and functional changes may be made without departing from the scope of the present invention. The foregoing descriptions of embodiments of the invention have been presented for the purposes of illustration and description. It is not intended to be exhaustive or to limit the invention to the precise forms disclosed. Accordingly, many modifications and variations are possible in light of the above teachings. It is therefore intended that the scope of the invention be limited not by this detailed description.

1. A permission-based marketing organization and delivery system, comprising:
a computer network having at least one server;
a plurality of user interface applications allowing at least one user to engage said computer network and said at least one server;
a central database for storing advertising information and end user information, the central database being coupled to said computer network; and
a plurality of additional database components, said additional database components storing information to be accessed by said central database.

2. The system of claim 1, wherein the central database includes a directory of content.

3. The system of claim 2, wherein the central database includes editorial material related to the content.

4. The system of claim 2, wherein the central database includes promotional material related to the content.

5. The system of claim 2, wherein the central database includes tracking data related to audience response to the content.

6. The system of claim 1, wherein the computer network includes at least one computer terminal connected to the at least one server, the at least one computer terminal facilitating the use of the plurality of user interface applications.

7. The system of claim 1, further comprising a search engine, said search engine being coupled to said computer network.

8. The system of claim 1, wherein said plurality of additional database components includes an orders database.

9. The system of claim 1, wherein an end user is an additional computer network.

10. A method of integrating licensors and licensees of media and advertisers, the method comprising:
registering content and promotional material with a central database;
identifying common characteristics between content and promotional material; and
allowing an end user to order content and to specify which promotional material is to be included with content.

11. The method of claim 10, further comprising distributing performance data related to said content to licensors of content and to advertisers.

12. The method of claim 10, further comprising distributing performance data related to said content to licensees.

13 The method of claim 11, further comprising matching advertisers with licensors and licensees.

14. The method of claim 12, further comprising delivering content and advertising to end users.

15. The method of claim 10, further comprising providing a directory of content, editorial material related to the content, promotional material related to the content, and tracking data related to audience response to the content to the central database.

16. The method of claim 10, further comprising providing a computer network including at least one computer terminal connected to at least one server.

17. The method of claim 10, further comprising providing a search engine.

18. The method of claim 10, further comprising providing plurality of additional database components, said plurality of additional database components including an orders database.

19. The method of claim 15, further comprising providing a computer terminal connected to the at least one server, the computer terminal allowing a user to interface with said computer network.

20. A method of delivering content over a computer network, the method comprising:
identifying common characteristics between content and promotional material;
identifying common characteristics between the content and promotional material and an end user;
allowing the end user to order content and to specify which promotional material is to be included with content; and
delivering content and advertising together in a common product.

21. The method of claim 20, further comprising accepting registration of content, promotional materials and end users.

22. The method of claim 20, further providing a computer network including at least one computer terminal connected to at least one server.

23. The method of claim 20, further comprising providing a search engine.

24. The method of claim 20, further comprising further comprising providing plurality of additional database components, said plurality of additional database components including an orders database.

25. The method of claim 20, further comprising providing a computer terminal connected to the at least one server, the computer terminal allowing a user to interface with said computer network.
